(19) United States
(12) Patent Application Publication
(10) Pub. No.: US 2009/0222862 A1
(43) Pub. Date: Sep. 3, 2009

(54) VIDEO PLAYER, DOCKING STATION AND SYSTEM FOR VEHICLE HAVING WIRELESS VIDEO TRANSMISSION

(76) Inventors: Mervin A. Dayan, Oakhurst, NJ (US); Maurice S. Dayan, Oakhurst, NJ (US); Larry D. Sharp, Tinton Falls, NJ (US)

Correspondence Address: The Belles Group, P.C., 1518 Walnut Street, Suite 1706, Philadephia, PA, 19102, US

(21) Appl. No.: 12/342,033

(22) Filed: Dec. 22, 2008

Related U.S. Application Data
(60) Provisional application No. 61/015,861, filed on Dec. 21, 2007.
(60) Provisional application No. 61/016,018, filed on Dec. 21, 2007.

(51) Int. Cl. H04N 7/18; G11B 17/04

(52) U.S. Cl. 725/75; 720/620; G9B/17.013

(57) ABSTRACT

A multimedia playing device for use in a vehicle. The multimedia playing device is mounted within the dashboard of a vehicle and is able to wirelessly transmit video to various display devices located in the vehicle. The multimedia playing device is able to accommodate any number of multimedia playing devices. The audio may be directly transmitted to the stereo system of the vehicle. In another aspect, the invention is a docking device for use in a vehicle. The docking device is adapted to be placed within the cup holder of a vehicle. An external media device is connected to the docking device in order to transmit the video and audio data. The docking device is able to wirelessly transmit video to display devices located in the vehicle. The audio may be directly transmitted to the stereo system of the vehicle and/or to the display device.

### CROSS-REFERENCE TO RELATED PATENT APPLICATIONS

The present application claims the benefit of U.S. Provisional Patent Application Ser. No. 61/015,861, filed Dec. 21, 2007, and U.S. Provisional Patent Application Ser. No. 61/016,018, filed Dec. 21, 2007, the entireties of which are hereby incorporated by reference.

### FIELD OF THE INVENTION

The present invention relates generally to the provision of entertainment systems in vehicles, and specifically to systems and methods for providing video within a vehicle.

### BACKGROUND OF THE INVENTION

In today's vehicles increasing measures are being provided to supply entertainment to the passengers. In the past passengers were content with radios and other simple audio devices. As time went by more sophisticated steps have been taken in order to provide entertainment to passengers.

Although the ability to play videos has been provided to passengers in the past there has been an inadequate provision of access to a variety of mediums on which video data may be stored. Further, while video data has been provided to passengers in automobiles in the past it frequently failed to provide ease of use and ease of portability. Additionally, there is frequently inadequate reproduction of the audio data that accompanies the video data as well as failures to provide an easy and non-cumbersome way of transmitting the information.

Thus, there is a need for a comprehensive multimedia player that is able to provide a passenger with the ability to accommodate a variety of media sources as well as enable adequate and easy reproduction of audio and video data. There is also a need for a portable multimedia player for use in vehicles that is able to provide a passenger with the ability to accommodate portable media sources as well as enable adequate reproduction of audio and video data.

### SUMMARY OF THE INVENTION

It is therefore an object of the present invention to provide a system and method that provides for comprehensive provision of audio and video data to passengers of a vehicle.

Another object of the present invention is to provide a system that is able to wirelessly transmit video data to display devices located within a vehicle.

Still another object of the present invention is to provide a system and method for transmitting audio data to the audio system of a vehicle.

Yet another object of the invention is to provide the capability of accommodating a variety of video and audio sources.

It is therefore an object of the present invention to provide a system and method that provides audio and video data to passengers of a vehicle.

Still another object of the present invention is to provide a system for transmitting audio data to the audio system of a vehicle.

Yet another object of the invention is to provide the capability of accommodating a portable video media source.

These and other objects are met by the present invention, which in a first aspect can be an apparatus for playing video and audio in a vehicle comprising: a housing adapted for placement within a dashboard of a vehicle; a first port located on a front face of the housing, wherein the first port is adapted to receive video and audio data stored on an external media storage device; a slot located on the front face of the housing, wherein the slot is adapted to receive an optical disc and provide the optical disc to an optical disk reader; a controller operably connected to the first port and the optical disk reader and adapted to process the audio data and transmit the audio data to an audio system of the vehicle; and a transmitter operably connected to the controller and adapted for wirelessly transmitting video data to a display unit.

A second aspect of the invention can be a system for playing video and audio in a vehicle comprising: a media player for playing video and audio data, wherein the media player is adapted to be installed in a dashboard of a vehicle; a transmitter located within the media player, wherein the transmitter is adapted for wirelessly transmitting the video data to a display device; means for connecting the media player to an audio system of a vehicle, wherein the audio data played by the media player is sent to the audio system of the vehicle; the display device having a means for mounting the display device within a passenger compartment of the vehicle, the display device further comprising a receiver for receiving the video data; and a display controller operably connected to the receiver for displaying the video data on the display device.

A third aspect of the invention can be a method for playing video and audio in a vehicle comprising the steps of: providing a media player for playing video and audio data in a vehicle; providing video and audio data to the media player; wirelessly transmitting video data to a display device located in the vehicle; and transmitting audio data to an audio system of the vehicle.

In another aspect, the invention can be an apparatus for providing video and audio in a vehicle comprising: a housing adapted for placement within a cup holder of a vehicle, wherein the housing has a top surface, a body portion and a bottom portion; a first port located on the housing, wherein the first port is adapted to receive video and audio data stored on an external media device; a controller operably connected to the first port and adapted to process the video and audio data; and a transmitter operably connected to the controller and adapted for wirelessly transmitting the video and audio data.

Yet another aspect of the invention can be a system for playing video and audio in a vehicle comprising: a docking device for receiving an external media device comprising and playing video and audio in a vehicle comprising: a housing adapted for placement within a cup holder of a vehicle, wherein the housing has a top surface, a body portion and a bottom portion; a first port located on the housing, wherein the first port is adapted to receive video and audio data stored on an external media device; a controller operably connected to the first port and adapted to process the video and audio data; and a transmitter operably connected to the controller and adapted for wirelessly transmitting the video and audio data to a display device, wherein the display device has means for mounting the display device within a passenger compartment of the vehicle, the display device further comprising a receiver for receiving the video data; and a display controller operably connected to the receiver for displaying the video data on the display device.

Still another aspect of the invention can be a method for playing video and audio in a vehicle comprising the steps of: providing a docking device for receiving video and audio data from an external media device in a cup holder of a vehicle; providing video and audio data to the docking device; wirelessly transmitting video data to a display device located in the vehicle; and wirelessly transmitting audio data to an audio system of the vehicle.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a view of the multimedia playing device according to an embodiment of the instant invention.

FIG. 2 is a view of the display device for use with the multimedia playing device shown in FIG. 1, according to an embodiment of the instant invention.

FIG. 3 is schematic illustrating an arrangement of the multimedia playing device and the display device shown in FIGS. 1 and 2, according to an embodiment of the instant invention.

FIG. 4 is diagram illustrating the interaction of the components of the system shown in FIG. 3.

FIG. 5 is a view of the docking device according to an embodiment of the instant invention.

FIG. 6 is a view of the display device for use with the docking device shown in FIG. 5, according to an embodiment of the instant invention.

FIG. 7 is schematic illustrating an arrangement of docking device and the display device shown in FIGS. 5 and 6, according to an embodiment of the instant invention.

FIG. 8 is a top down view of the docking device placed within a vehicle's cupholder.

FIG. 9 is diagram illustrating the interaction of the components of the system shown in FIG. 7.

FIG. 10 is a view of an alternative docking device according to an embodiment of the instant invention.

FIG. 11 is top down view of the docking device according to the embodiment shown in FIG. 10, placed within a vehicle's cup holder.

### DETAILED DESCRIPTION OF THE DRAWINGS

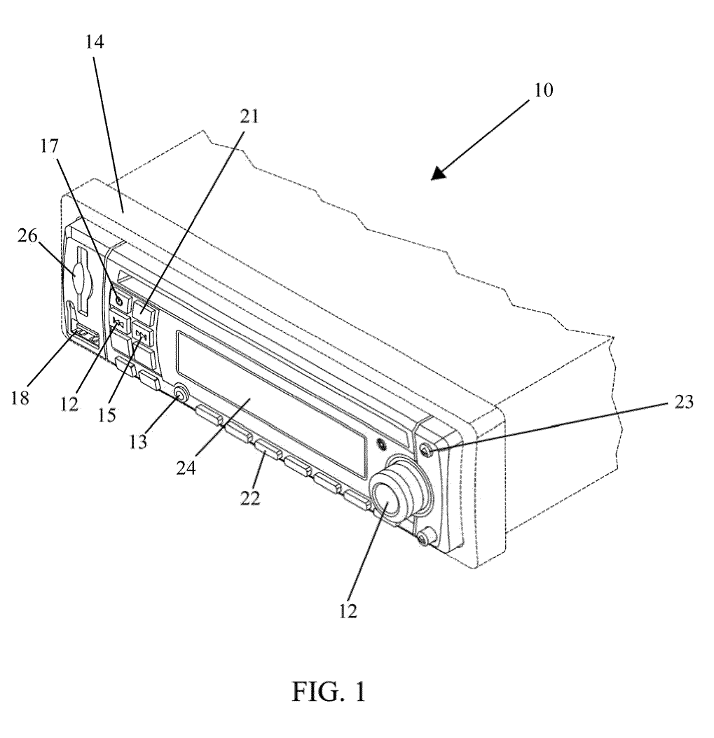

FIG. 1 is a view of the multimedia playing device 10 according to an embodiment of the instant invention. The multimedia playing device 10 is designed so as to be installed into the dashboard of a vehicle similar to the way in which traditional car stereos are installed. It may be pre-installed in a vehicle or designed to be placed within the dashboard of the vehicle after a vehicle has been sold.

The multimedia playing device 10 comprises a housing 14 in which the components of the multimedia playing device 10 are contained. The housing 14 has a front face on which the controls are located as well as the various ports and slots that receive the media devices on which video and audio data are stored and/or transferred from.

In the embodiment shown in FIG. 1 multiple types of media devices may be accommodated. Slot 16 is adapted to receive an optical disc for playback. The optical disc may be a Digital Video Disc (DVD), a Compact Disc (CD) or another type of optical disc. In preferred embodiments the type of disc that is inserted is detected and playback of the disc on the optical disk player 73 commences based upon the format and type of disc.

A Universal Serial Bus (USB) port 18 is provided on the face of the housing 14 and is adapted to receive a USB plug. Typically this USB plug is attached to an external media device that may store and/or play video and audio data. The device may be a personal computer, or a handheld device such as video Ipod® that stores video and audio data in some type of video and/or audio format. Video formats that may be used are MPEG-4, AVI, WMV-9, and DRM. Audio formats that may be used are MP3, WMA, OGG, VGF, WAV, etc. The video and audio data from the external media device is transferred to the controller 72 through the USB port 18 for playback.

A Secure digital (SD) card port 26 is provided on the face of the housing 14 and is adapted to received a SD card. An SD card is capable of storing large amounts of data in a very small space. The SD card port 26 is operably connected to the controller 72. When an SD card is placed in the card port 26 the controller 72 is able to process the data contained on the card.

Other types of ports and/or slots may be provided in the face of the housing 14 in order to accommodate additional types of media devices, such as IEEE 1394 ports and HDMI cables.

Still referring to FIG. 1, various other features are located on the face of the housing 14 that function to enable operation of the multimedia playing device 10. A power button 17 is provided on the face of the housing 14 and is depressed in order to turn the multimedia playing device 10 on and off. A power indicator light 23 is also provided on the face of the housing 14 in order to indicate whether or not the multimedia player device 10 is turned on or not.

A mode button 21 may be used to switch the multimedia playing device 10 between various operation modes, such as switching between activating the radio, or to send a signal in order to indicate that data should be received from the SD card port 26, from the USB port 18 or from the optical disc player 73. The mode button 21 may also be used to indicate whether or not the audio should be played through the audio system 80 of the vehicle or should be transmitted to a display device 40. It is also possible to have the multimedia player device 10 detect the type of media that is being loaded and to automatically initiate playback upon detection of the media within the device as opposed to using the mode button 21.

Knob 12 is used to tune the radio multimedia player device 10. The display 24 shows the setting of the radio device as well as to display information related to the video and audio data that is being accessed. Pre-set button 22 is used to automatically switch the radio tuner to a desired setting.

Also provided on the face of the housing 14 is an audio jack 13 that may be used in order to listen to audio through head phones. Alternatively the audio jack 13 may be used in order to provide audio and/or video to and/or from an external media device or the display device 40.

Other standard video playback buttons are provided on the face of the housing 14, such as the fast forward button 15 and the rewind button 12. Other buttons such as pause, play, skip, etc. may also be provided. Other features such as an infrared sensor may also be located on the housing 14 so as to enable remote control of the functions of the media playback device 10.

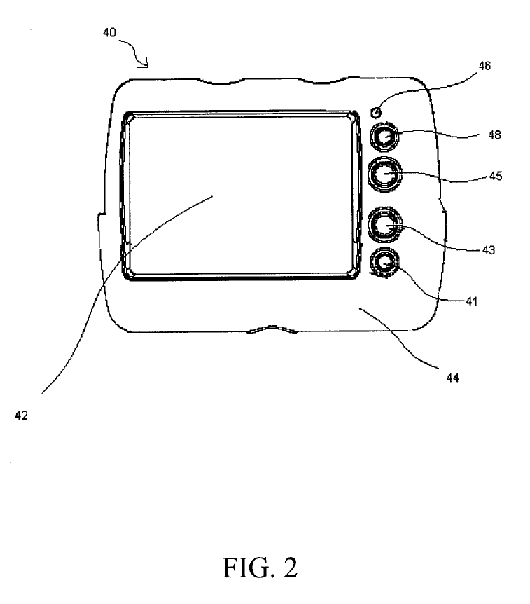

FIG. 2 is a view of a display device 40 that may be used with the multimedia player device 10 shown in FIG. 1, according to an embodiment of the instant invention. The display device has a housing 44 that houses the various components of the display device 40. The display screen 42 may be a LCD screen that may be sized to be readily placed within a vehicle and is typically between 3″ and 10″.

The display device 40 has a video input 46 that is provided on the display housing 44 that can accommodate a cable that can be extended from an external media device. It is intended that the video input 46 may receive video data for reproduction on the screen 42. It may also operate as means for charging the external media in some instances.

The display device 40 may have a series of controls located on the display housing 44. Some of the controls that may be provided are a contrast 48 that can control the contrast of video displayed on the screen 42 and a brightness 45 that can control the brightness of the picture shown on the screen 42. A power button 41 is used in order to turn the display device 40 on and off. The display device 40 may also be triggered to turn on when it receives video data from the media playback device 10.

The volume 43 may be an optional control that is used when the video input 46 is being used and is used to control the volume of audio that is produced by the display device 40. Alternatively, the volume 43 may control the audio in those instances where the audio is being transmitted from the multimedia player device 10 instead of being played through the vehicle's audio system.

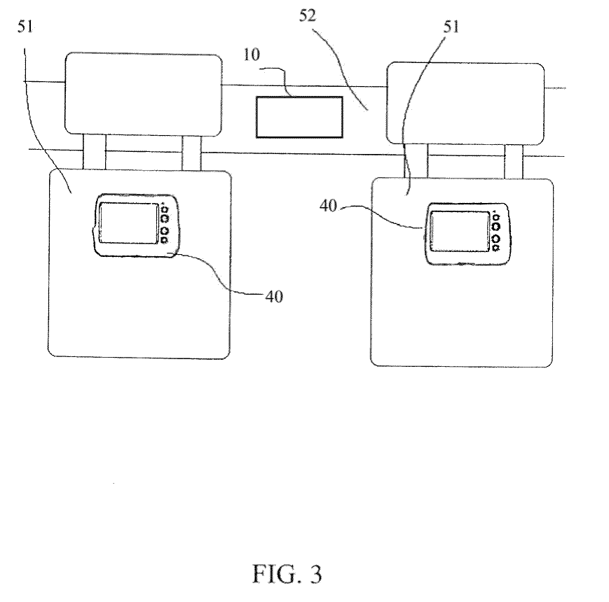

FIG. 3 is schematic illustrating an arrangement in a vehicle of the multimedia playing device 10 and the display device 40, shown in FIGS. 1 and 2, according to an embodiment of the instant invention. As shown the display devices 40 are placed upon the rear of seats 51. A display device 40 may be permanently mounted within the seat 51 or may be removably secured to the seat 51 using any number of attachment means such as straps, hook and loop tape, adhesive material, snap fixtures, etc. It is also possible to mount the display device 40 at other locations within the vehicle, such as in the front of a vehicle, or designed to fold down from the roof of the vehicle. The multimedia player device 10 may be mounted either permanently or removably within the dashboard 52 of a vehicle. Together the multimedia player device 10 and the display devices 40 may be part of a package that is installed in the vehicle at some point after the construction of the vehicle.

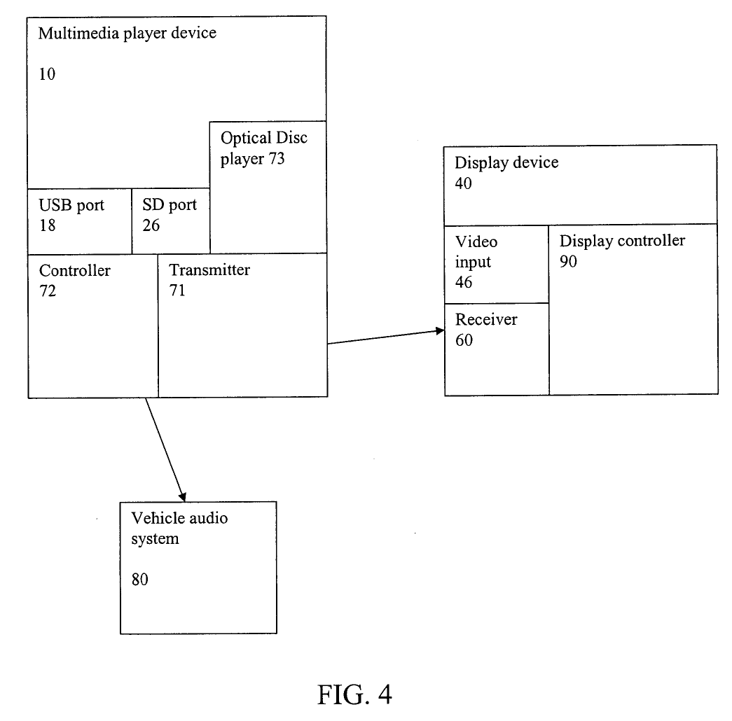

FIG. 4 is diagram illustrating the interaction of the components of the system shown in FIG. 3. The multimedia player device 10 has a controller 72 and a transmitter 71 as well as a number of means for reproducing video data, such as the optical disc player 73, the USB port 18 and the SD port 26. The multimedia player device 10 may also use a IEEE 1394 port (i.e. a firewire port). The controller 72 operates to receive the video data that is received from the various sources and to provide that video data to the transmitter 71. The controller 72 has the necessary drivers loaded thereon so that it is able to reproduce data that is transmitted by devices connected through the USB port 18 or from SD cards placed in the SD port 26.

For example, when a user of the multimedia player device 10 places a DVD disc into the slot 16 the optical disc player 73 will receive it. In a preferred embodiment, the optical disc player 73 is capable of playing both CDs and DVDs, in which case the optical disc player 73 first determines the format of the disc. When it is determined that a DVD disc has been placed within the optical disc player 73 the video and audio data read from the disc will be transmitted to the controller 72. When the video and audio data is received at the controller 72 it may be processed so that the data is split between the audio and the video data.

The video data will be sent to the transmitter 71, while the audio data is sent to the vehicle audio system 80 in order to provide audio throughout the vehicle. Preferably the video is transmitted at roughly 2.4 GHz to the display device 40. The vehicle audio system 80 may comprise pre-installed speakers in the vehicle, or speakers that have installed at some later point. In alternative embodiments that audio data may also be sent to the transmitter 71 for reproduction in the display device 40. If the audio data is transmitted to the display device 40 it may be transmitted at frequencies between 88.1-107.9 MHz or it may be transmitted at the same frequency as the video data.

Still referring to FIG. 4, after the video data is sent to the transmitter 71 it is transmitted to the receiver 60 of the display device 40. When the video data is received at the receiver 60 it is then transmitted to the display controller 90. The display controller 90 takes the video data and uses it to produce a picture on the screen 42 of the display device 40. In the event that audio data is also transmitted to the receiver 60, the display controller 90 will take the audio data and provide it the audio system of the display device 40.

In an alternative embodiment, it is possible for the display device 40 to also have a transmitter. In this embodiment, an external media device may be connected to the display device 40 through the video input 46. The video data would be sent to the display controller 72 in order to display the video on the screen 42. Audio data may also then be transmitted through the video input 46 or through a special audio input provided in the housing 44 of the display device 40. The audio data may be sent to the display controller 90 and then to a transmitter which would then transmit the audio data to a receiver located in the multimedia player device 10. The audio is preferably transmitted at a frequency between the range of 88.1-107.9 MHz. The multimedia player device 10 then transmits the data to the vehicle audio system 80.

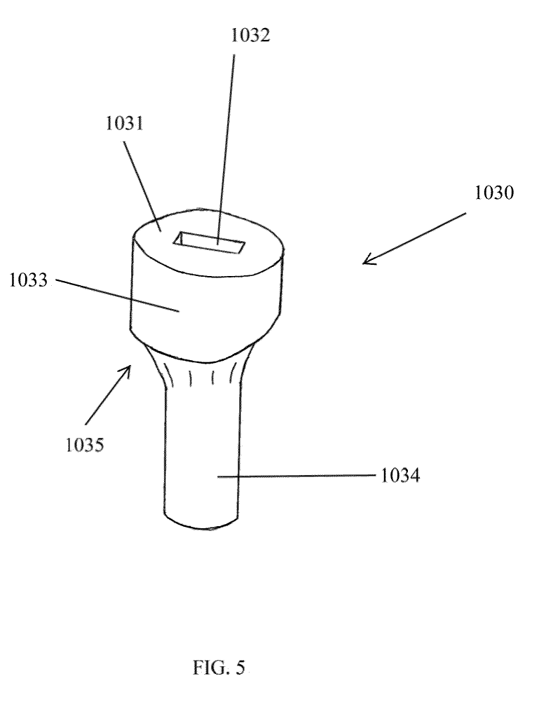

Referring now to FIG. 5, a docking device 1030 according to an embodiment of the instant invention is illustrated. The docking device 1030 is designed to be installed into a cup holder of a vehicle.

Docking device 1030 comprises a housing 1035 in which the components of the docking device 1030 are contained. The housing 1035 has a top surface 1031 at which a port 1032 is located. The housing 1035 also has a body portion 1033 that is cylindrical in shape and is sized to be larger in diameter than the diameter of a cup holder located in a vehicle. The housing 1035 has a bottom portion 1034 that is sized to be placed within the cavity of a cup holder.

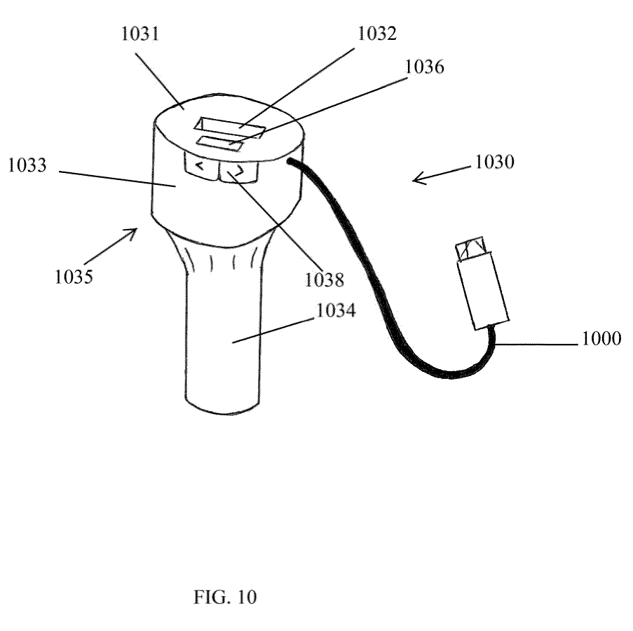

On the base of the bottom portion 1034 there may be a cover (not shown) that when removed permits the placement of batteries into the docking device 1030. In an alternative embodiment, shown in FIGS. 10 and 12, a 12 V adapter cord 1061 is used to power the docking device 1030.

Returning to the embodiment shown in FIG. 5, the port 1032 may be a Universal Serial Bus (USB) that is provided at a top surface 1031 of the housing 1035 and is adapted to receive a USB plug or a IEEE 1394 port (i.e. a firewire port). Typically this USB plug is attached to an external media device, that in the instant embodiment preferably plays and/or stores video data. This device may be a personal computer, or other handheld device such as video Ipod® that stores and/or plays video and audio data in some type of video and/or audio format. Video formats that may be used are MPEG-4, AVI, WMV-9, and DRM. The audio formats that may be used are MP3, WMA, OGG, VGF, WAV, etc. The video and audio data from the external media device is transferred to the docking controller 1072 of the docking device 1030.

In an alternative embodiment the port 1032 may be Secure Digital (SD) card port that is located at a top surface 1031 of the housing 1035 and is adapted to receive a SD card. An SD card is capable of storing large amounts of data in a very small space. In embodiments that utilized SD cards, the controller 1072 is adapted to process the data that is stored on the SD card.

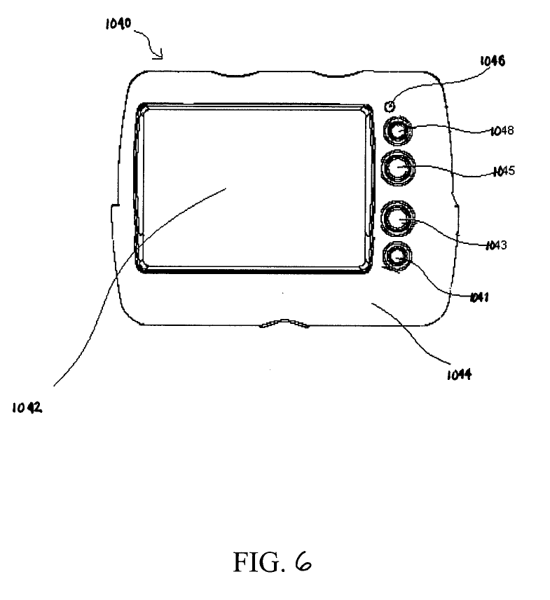

FIG. 6 is a view of the display device 1040 that may be used with the docking device 1030 shown in FIG. 5, according to an embodiment of the instant invention. The display device 1040 may utilize batteries or be charged via the usage of a 12 V cable. The display device 1040 has a housing 1044 that houses the various electrical components. The display screen 1042 may be a LCD screen that may be sized to be readily placed within a vehicle. The screen 1042 may be sized to be between 3″-10″.

The display device 1040 may have a video input 1046 that is provided on the display housing 1044 that can accommodate a cable that may be extended from an external media device. It is intended that the video input 1046 may receive video signals for reproduction on the screen 1042. It may also operate as means for charging a video or audio player in some instances.

The display device 1040 may have a series of controls located on the display housing 1044. Some of the controls that may be provided are a contrast 1048 that can control the contrast of video displayed on the screen 1042 and a brightness 1045 that can control the brightness of the picture shown on the screen 1042. A power button 1041 is used in order to turn the display device 1040 on and off. The display device 1040 may also be triggered to turn on when it receives video data from the docking device 1030.

The volume 1043 may be an optional control that is used when the video input 1046 is being used and is used to control the volume of audio that is produced by the display device 1040. Alternatively, the volume 1043 may control the audio in those instances where the audio is being transmitted from the docking device 1030 instead of being played through the vehicle's audio system.

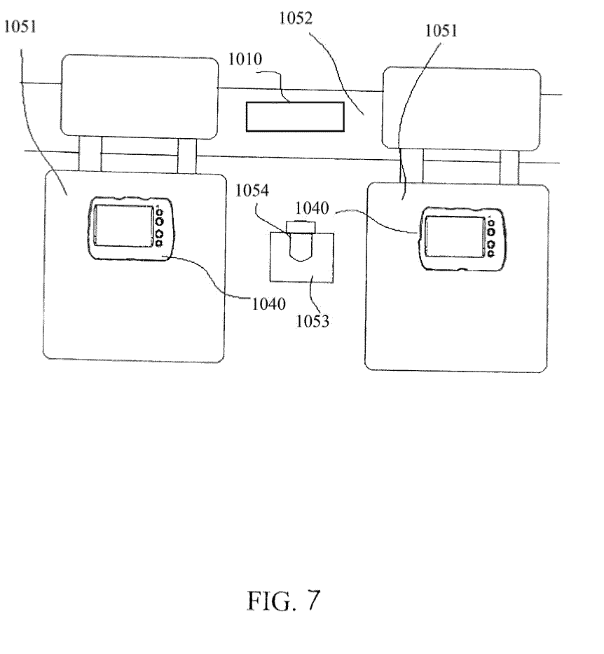

FIG. 7 is diagram illustrating an arrangement of the docking device 1030 and the display device 1040, shown in FIGS. 5 and 6, according to an embodiment of the instant invention. As shown the display devices 1040 are placed upon the rear of seats 1051. The display device 1040 may be permanently mounted within the seat 1051 or may be removably secured to the seat 1051 using any number of attachment means such as straps, hook and loop tape, adhesive material, snap fixtures, etc. It is also possible to mount the display device 1040 at other locations within the vehicle, such as in the front of a vehicle, or designed to fold down from the roof of the vehicle. A stereo device 1010 is mounted either permanently or removably within the dashboard 1052 of a vehicle.

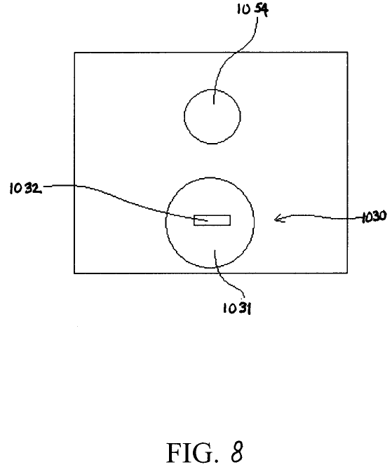

In many vehicles a center arm rest 1053 may be provided that has a cup holder 1054 or cup holders provided therein. As shown in FIGS. 7 and 8, the docking device 1030, which is shaped as described above is placed within the cup holder 1054 so as to be conveniently situated within the vehicle.

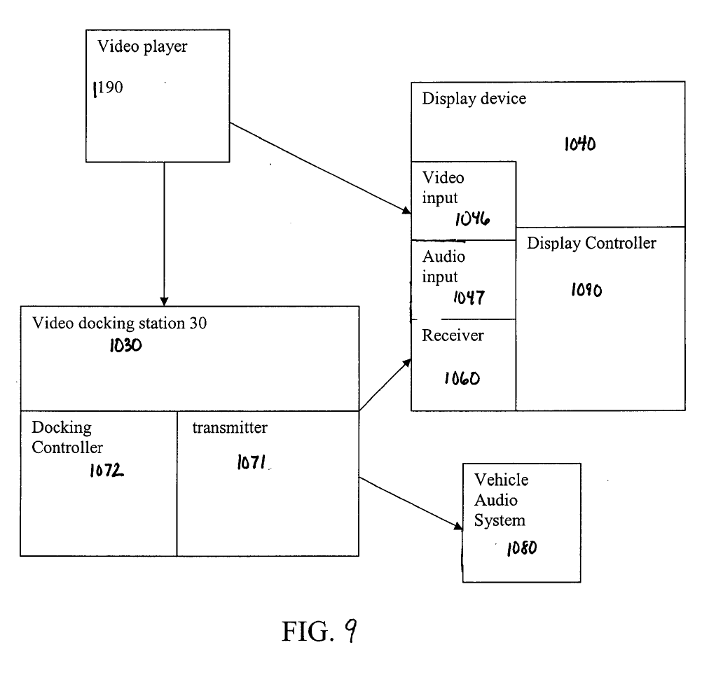

FIG. 9 is diagram illustrating the interaction of the components of the system shown in FIGS. 7 and 8. The docking device 1030 has a docking controller 1072 and a transmitter 1071. The docking controller 1072 operates to receive the video data that is received through the port 1032 and to provide that video data to the transmitter 1071. The controller 1072 has the necessary drivers loaded thereon so that it is able to reproduce data that is transmitted by devices connected through a USB plug or from SD cards.

For example, a user of the docking device 1030 places a external media device 1190, such as a VideoIpod into the slot 1032. When the video and/or audio data is received at the controller 1072 it may be parsed so that the data is split between audio and video data. The data is then sent to the transmitter 1071. The transmitter 1071 may have the ability to transmit at a variety of frequencies or alternatively have both a dedicated audio sub-transmitter and a dedicated video sub-transmitter. Preferably the video is transmitted at roughly 2.4 GHz. The audio is preferably transmitted at a frequency selected from the range of 88.1-107.9 MHz so that it can be played through the vehicle audio system 1080. The vehicle audio system 1080 may comprise pre-installed speakers in the vehicle, or speakers that have installed at some later point. In alternative embodiments that audio data may also be sent to the display device 1040. In these instances the audio data may be transmitted at the same frequency as the video data and may processed by the display controller 1090.

Still referring to FIG. 9, after the video data is sent to the transmitter 1071 it is transmitted to the receiver 1060 of the display device 1040. When the video data is received at the receiver 1060 it is then transmitted to the display controller 1090. The display controller 1090 takes the video data and uses it to produce a picture on the screen 1042 of the display device 1040. In the event that the audio data is also transmitted to the receiver 1060, the display controller 1090 will take the audio data and provide it the audio system of the display device 1040.

In an alternative embodiment, it is possible for the display device 1040 to also have a transmitter. In this embodiment, an external media device, which may store and/or play media, may be connected to the display device 1040 through the video input 1046. The video data would be sent to the display controller 1090 in order to display the video on the screen 1042. Audio data may also then be transmitted through the video input 1046 or through a special audio input 1047 provided in the housing 1044 of the display device 1040. The audio data is sent to the display controller 1090 and then to a transmitter which would then transmit the audio to the receiver of the stereo system 1010.

FIG. 10 is a view of an alternative docking device 1030 according to an embodiment of the instant invention. The docking device 1030 has a display 1036 located on the top surface 1031 that illustrates at which frequency the audio data is being transmitted. A frequency selector 1038 is provided on the body portion 1033 in order to permit a user to move up and down in frequency in order to select the desired frequency at which a user wishes to transmit.

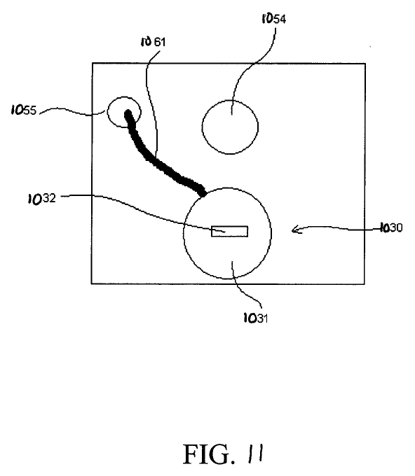

FIG. 11 is top down view of the docking device 1030 according to the embodiment shown in FIG. 10 placed within a vehicle's cup holder 1054. The docking device 1030 has an adapter cord 1061 that is placed in a 12 V cigarette lighter 1055 of a vehicle. When using the adapter cord 1061, the docking device 1030 may also operate to charge any device that is connected to it.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An apparatus for playing video and audio in a vehicle comprising:
a housing adapted for placement within a dashboard of a vehicle;
a first port located on a front face of the housing, wherein the first port is adapted to receive video and audio data stored on a first external media device;
a slot located on the front face of the housing, wherein the slot is adapted to receive an optical disc and provide the optical disc to an optical disc reader;
a controller operably connected to the first port and the optical disc reader and adapted to process the audio data and transmit the audio data to an audio system of the vehicle; and
a transmitter operably connected to the controller and adapted for wirelessly transmitting video data to a display unit.

2. The apparatus of claim 1, further comprising a second port located on a front face of the housing, wherein the second port is adapted to receive video and audio data stored on a second media device and is operably connected to the controller.

3. The apparatus of claim 2, wherein the first port is a USB port;

4. The apparatus of claim 3, wherein the second port is a SD card port.

5. The apparatus of claim 4, wherein the transmitter is further adapted for wirelessly transmitting the audio data.

6. The apparatus of claim 5, further comprising means for switching between the media sources.

7. The apparatus of claim 6, further comprising means for automatically detecting the presence of media source.

8. A system for playing video and audio in a vehicle comprising:
a media player for playing video and audio data, wherein the media player is adapted to be installed in a dashboard of a vehicle;
a transmitter located within the media player, wherein the transmitter is adapted for wirelessly transmitting the video data to a display device;
means for connecting the media player to an audio system of a vehicle, wherein the audio data played by the media player is sent to the audio system of the vehicle;
the display device having a means for mounting the display device within a passenger compartment of the vehicle, the display device further comprising a receiver for receiving the video data; and
a display controller operably connected to the receiver for displaying the video data on the display device.

9. The system of claim 8, wherein the media player comprises;
a housing adapted for placement within a dashboard of a vehicle;
a first port located on a front face of the housing, wherein the first port is adapted to receive video and audio data stored on an external media device;
a slot located on the front face of the housing, wherein the slot is adapted to receive an optical disc and provide the optical disc to an optical disc reader;
a controller operably connected to the first port and the optical disc reader.

10. The system of claim 9, wherein the first port is a USB port;

11. The system of claim 10, wherein the second port is a SD card port.

12. The system of claim 11, wherein the transmitter is further adapted for wirelessly transmitting the audio data.

13. The system of claim 12, further comprising means for switching between the media sources.

14. The system of claim 13, further comprising means for automatically detecting the presence of media source.

15. The system of claim 14, wherein the display device further comprises a video input adapted to receive a cable from an external media storage device.

16. A system for playing video and audio in a vehicle comprising:
a docking device for receiving an external media device comprising and providing video and audio in a vehicle comprising:
a housing adapted for placement within a cup holder of a vehicle, wherein the housing has a top surface, a body portion and a bottom portion;
a first port located on the housing, wherein the first port is adapted to receive video and audio data stored on an external media device;
a controller operably connected to the first port and adapted to process the video and audio data; and
a transmitter operably connected to the controller and adapted for wirelessly transmitting the video and audio data to a display device, wherein the display device has means for mounting the display device within a passenger compartment of the vehicle, the display device further comprising a receiver for receiving the video data;
a display controller operably connected to the receiver for displaying the video data on the display device.
